(19) United States
(12) Patent Application Publication
(10) Pub. No.: US 2018/0219766 A1
(43) Pub. Date: Aug. 2, 2018

(54) Method and Apparatus for Network Traffic Control Optimization

(71) Applicant: Waltz Networks, San Francisco, CA (US)

(72) Inventors: Nithin Michael, San Francisco, CA (US); Ao TANG, San Francisco, CA (US)

(21) Appl. No.: 15/490,952

(22) Filed: Apr. 19, 2017

Related U.S. Application Data
(63) Continuation-in-part of application No. 15/421,409, filed on Jan. 31, 2017.

(51) Int. Cl. H04L 12/707; H04L 12/26; H04L 12/741

(52) U.S. Cl. CPC H04L 45/22; H04L 45/24; H04L 45/745; H04L 43/0864

(57) ABSTRACT

Alternate data packet routing includes employing the public internet as well as an existing enterprise MPLS network. Data is more optimally routed using multipath routing algorithms, rather than traditional single path routing as typical in MPLS networks. In an embodiment, if a particular path is experiencing delays (as indicated by latency measurement), any alternative path can be used provided the alternative path has a round-trip time less than a predefined performance requirement time. Embodiments include collecting packet traffic data and generating routing tables that may indicate more efficient routes (including public internet routes) not available through the ISP routing procedures.

### RELATED APPLICATIONS

This application is a continuation-in-part (CIP) of U.S. patent application Ser. No. 15/421,409, filed Jan. 31, 2017, which is incorporated by reference in its entirety herein.

### BACKGROUND

Business enterprises rely on electronic communications to communicate within the enterprise and also to provide a reliable electronic business portal to customers and partner businesses. The expectation of fast and available communication is increasingly the norm among those inside the enterprise as well as enterprise customers. Currently, businesses with enterprise networks purchase dedicated bandwidth from an internet service provider (ISP) to carry data traffic between and among enterprise physical sites. These enterprise networks are referred to as private networks, and also as MPLS networks (after the network protocol used). In fact, ISPs usually offer different levels of service that are priced largely based on the performance guarantee factor. ISPs typically set up an enterprise network for an enterprise client. This enterprise network defines physical enterprise locations and network nodes sometimes referred to as an overlay network, meaning a network maintained by the service provider that connects the enterprise sites with possible physical router stops between enterprise sites. The performance guaranteed by the ISP and paid for by the enterprise is typically greater than can be relied upon when exclusively using the public internet. However, in some situations enterprise network traffic performance could be improved upon. There is a need for a method and apparatus that can improve network traffic performance whether the main protocol is MPLS, public internet, or combination of both.

### BRIEF DESCRIPTION OF THE FIGURES

FIG. 1 is a block diagram of an enterprise data network according to an embodiment.

FIG. 2 is a flow diagram of a routing method according to an embodiment.

FIG. 3 is a diagram illustrating WALTZ overlay routing according to an embodiment.

FIG. 4A is an example of a routing overlay table according to an embodiment.

FIG. 4B is an example of a routing overlay table according to an embodiment.

FIG. 5 is a block diagram of a WALTZ router according to an embodiment.

FIG. 6 is a block diagram of an embodiment that uses the public internet to enhance performance of networks.

### DETAILED DESCRIPTION

Embodiments disclosed include a method and apparatus for global traffic control and optimization for software-defined networks. In an embodiment, data traffic in an enterprise wide area network (WAN) is optimized by providing alternate routing in addition to internet protocol routing supplied by an internet service provider (ISP). Alternate routing includes defining a new overlay network that leverages any available routers between data origination and destination points. Data over the new overlay network (also referred to as the WALTZ overlay network herein) is optimally routed using multipath routing algorithms, rather than traditional single path routing. In an embodiment, if a particular path is experiencing delays, any alternative path can be used provided the alternative path has a round-trip time less than a predefined performance requirement time.

The alternate routing includes using embodiments of a data network processor or router (referred to herein for convenience as a Waltz router or point-of-presence (“POP”), but generally to be understood as a data network processor) collocated with an ISP router (or ISP processor). Other embodiments include an ISP router running embodiments of routing software (referred to herein for convenience as Waltz routing software) that implement an alternate routing method in addition to the ISP routing method. The Waltz routing software may be resident anywhere. That is, the Waltz routing software may be resident on a Waltz router, or an enterprise router, or an ISP router or accessed from the cloud. In some embodiments, the routing software measures route utilization and adjusts routing based on which routes are more or less utilized.

In other embodiments, the routing software measures latency and adjusts routing based on which routes are experiencing greater or lesser latency. Such embodiments can use a combination of routes through ISP (enterprise) routers and the public internet to improve performance.

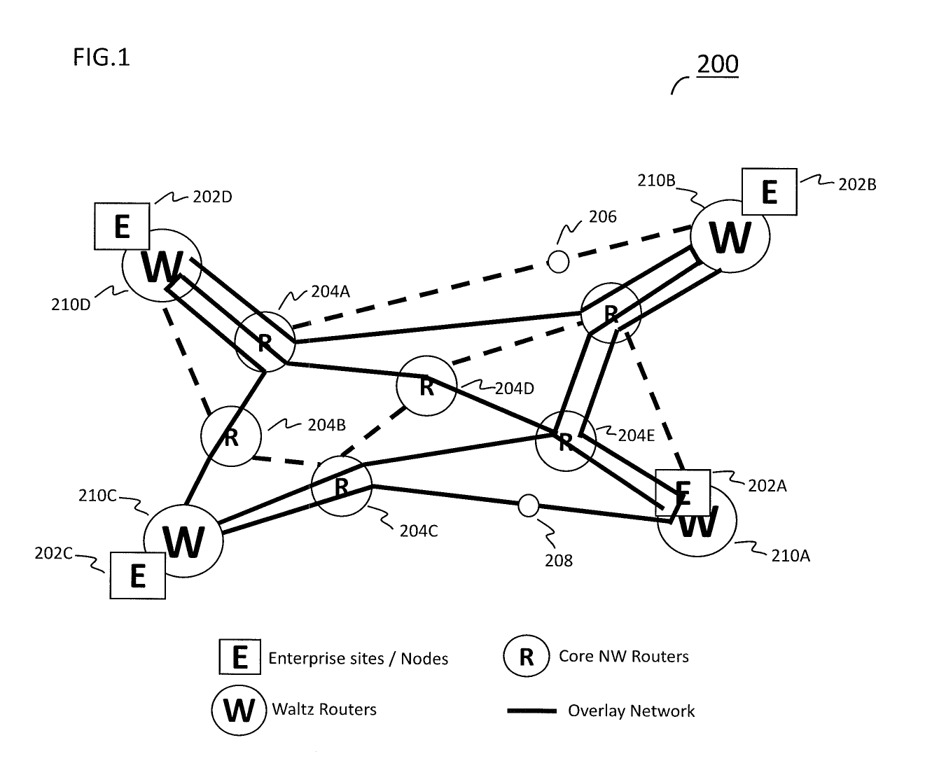

FIG. 1 is a block diagram of an enterprise network 200 according to an embodiment. In this example embodiment, there are four enterprise nodes 202A-202D. The nodes 202 can be referred to as the edge network. Nodes 202 typically include ISP routers/and or ISP routing software (not shown). The ISP also has multiple ISP network routers or nodes, labeled as nodes 204A, 204B, 204C, 204D, and 204E. These nodes 204 can be referred to as the core network. The enterprise contracts with an ISP (such as ATT for example) for a guaranteed level of data transmission service between and among its enterprise edge network nodes. Waltz routers 210A-210D are (in this example) also present at respective enterprise edge network nodes. Waltz routers 210A-210D have access to network traffic data and to the ISP routing tables used to optimize the enterprise traffic.

According to embodiments of the invention, Waltz routers 210 optimize traffic for the network by determining alternate routes that would not otherwise be detected or chosen by the ISP. As shown in the figure, heavier lines 208 represent the overlay network as provisioned by the ISP for the enterprise. The ISP routes data traffic according to MPLS protocols and available overlay network routers. However, there may be more efficient routes for data at any given time that are not detectable using MPLS. Routes 206 represent alternative routes that are more efficient at any given time as determined by the methods disclosed herein.

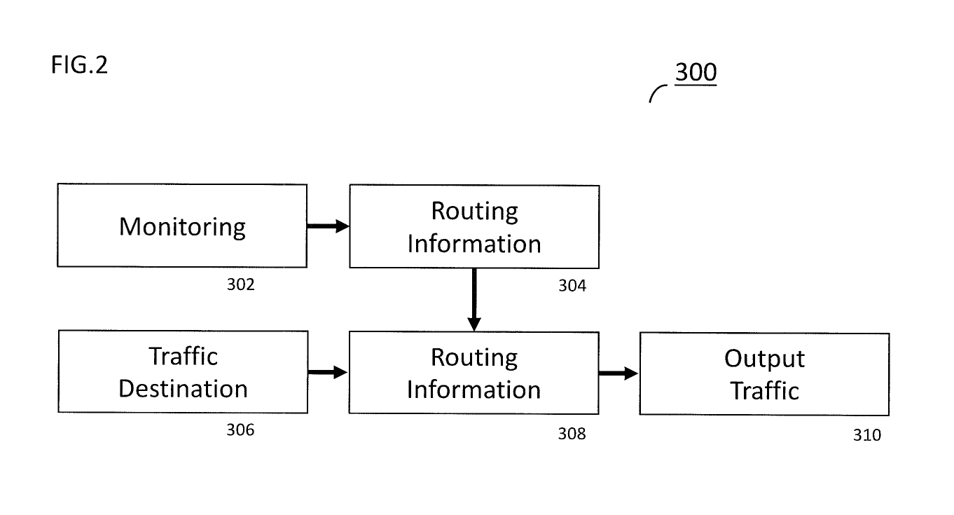

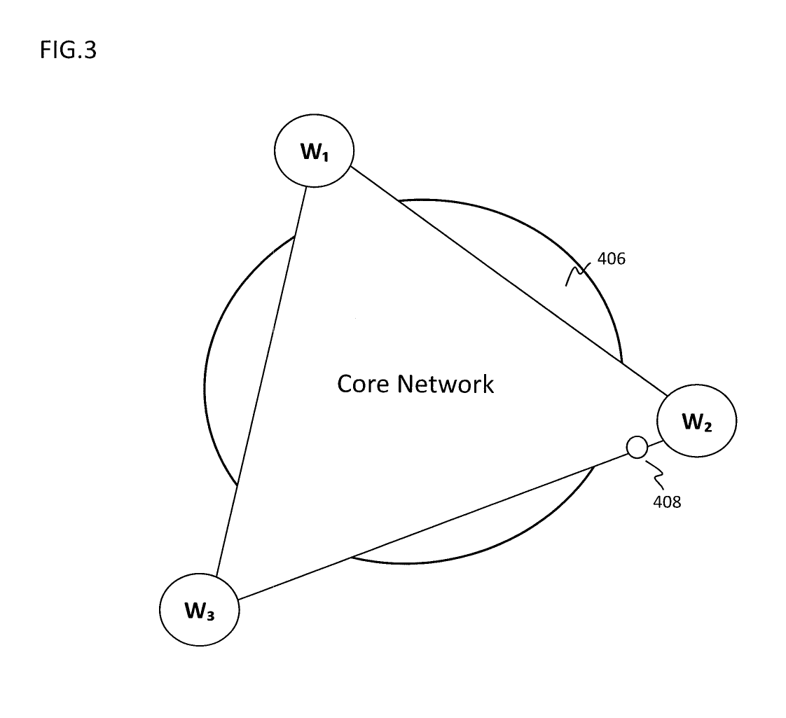

FIG. 2 is a flow diagram of a data routing method 300 according to an embodiment. At 302, the data traffic is monitored to determine whether the current routing is optimum. This includes monitoring route utilization to each enterprise node. Concurrently, at 306, the traffic destination is determined for particular packets of data. At 304, routing information (for example, the routing table that is generated by the ISP) is obtained and analyzed. If some routes are over-utilized and latency can be reduced, a load adjustment is made at 308. This includes adaptively adjusting the load from any outgoing link that belongs to a non-shortest path to a link that is part of a shortest path. Output traffic 310 is a result of the process. Output traffic 310 is a routing plan that can use any combination core network routers to get traffic between edge network routers in the most efficient manner. In an embodiment, the process illustrated by FIG. 3 uses algorithms described in the document “HALO: Hop-by-Hop Adaptive Link-State Optimal Routing” (Nithin Michael et al., IEEE 2014) which is hereby incorporated by reference in its entirety. The algorithms disclosed in the previous reference are just one example of algorithms that may be employed to carry out the claimed invention.

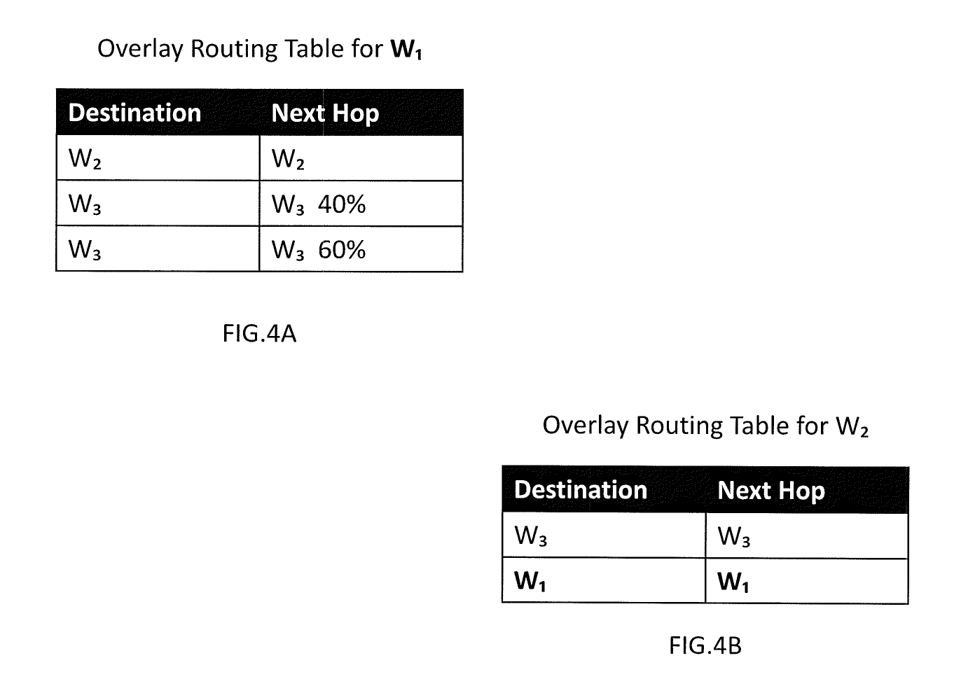

FIG. 3 is a representation of WALTZ overlay routing according to an embodiment. A core network 406 is similar to core network 204 as illustrated and described FIG. 1. A WALTZ overlay network 408 shows for purposes of example, three WALTZ routers W1, W2, and W3 Still with reference to FIG. 3, FIGS. 4A and 4B are diagrams of overlay routing tables for router W1 and router W2, respectively. In order to generate these tables, at any time, Waltz router exchange probes to keep track of the link load, where “link” in this context implies a link of the overlay network which connects Waltz router, which may well correspond to a path of the underlying core network.

In effect, an overlay IP network is formed among Waltz routers. The overlay IP network is an all-to-all mesh network. When a packet arrives at a Waltz router the Waltz router forms a routing table which decides to which next hop router (another Waltz router) to which this packet should go based on link cost, which depends on link load. The next hop Waltz router may sit in the destination site in which case, it will route the packet to that site. In the case when the next hop Waltz router does not sit in the destination site for that packet, it will again look up its routing table and forward that packet to another Waltz router. In each transmission between two Waltz routers, the packet typically transitions through the core network, whose routing is determined by the service provider (ISP). However, the WALTZ routers use all routers in both the core network and the overlay network to find an optimum route for a packet.

FIG. 4A is a diagram of a routing table for router W1 The destination router is listed in the left column and the next hop router is listed in the right column. In some instances, as shown, the destination router may be the same as the next hop router, as in the first and second rows. The third row shows that even though W3 router is the destination router, W2 is a better next hop router (60%) as compared to row two (W3 as the destination router and next hop router—40%).

FIG. 4B is a diagram of a routing table for router W2. In this example, the destination routers and next hop routers are the same.

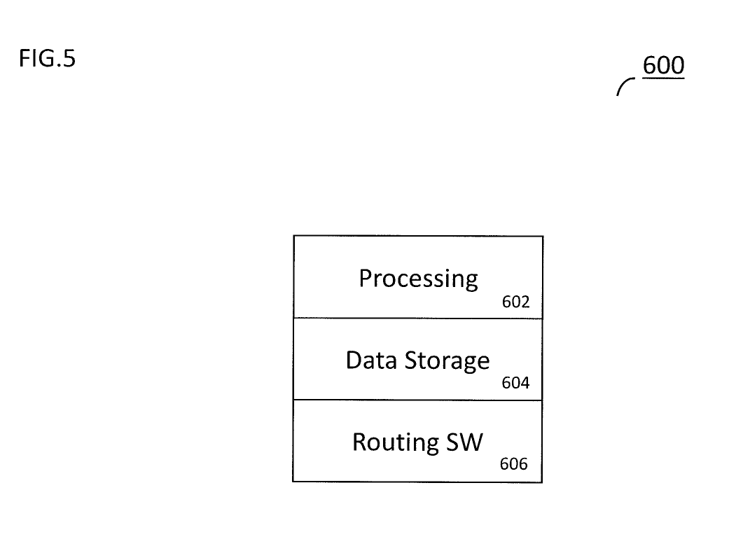

FIG. 5 is a block diagram of a WALTZ router 600 according to an embodiment. Router 600 includes processing equipment 602 which is one or more processors for executing routing software 606. Routing software 606 embodies the routing methods as described herein by executing instructions to carry out the methods. WALTZ router 600 also includes data storage 604 for storing data and instruction required to implement the claimed methods. Storage of data by data storage 604 as well as execution of instructions by processors 602 may be distributed in any logical or geographic manner among different WALTZ routers 600 or any other processors or data storage facilities.

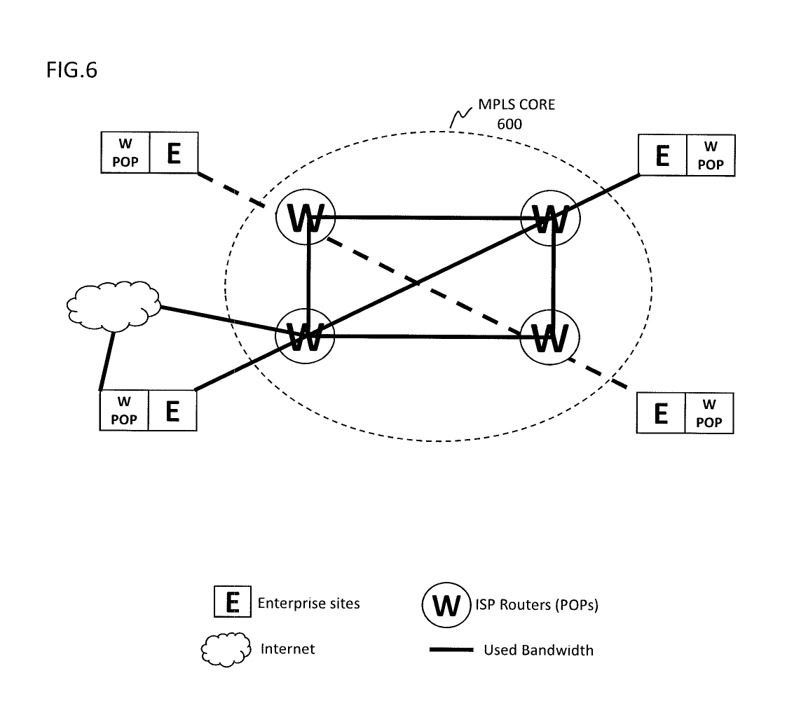

FIG. 6 is a diagram of an embodiment that uses the public internet to enhance performance of networks. Enterprise networks traditionally use MPLS networks with dedicated bandwidth between each pair of sites to obtain a level of performance. Increasingly, enterprises are switching to using the public internet in addition to the enterprise network to save cost and provide more bandwidth. The internet architecture usually cannot provide MPLS-like performance. However, because any MPLS link may be congested at any time, an embodiment provides a joint service provider and enterprise solution for cases in which some internet routes may provide better performance than traditional MPLS links. The result is an “almost MPLS” quality service without further bandwidth investment from either service provider or enterprise.

As shown in FIG. 6, there is a core enterprise network 600 that is typically an MPLS network. Within the core network 600 are ISP routers with collocated POPs (labeled W. In addition to the POPs within the core 600 are other POPs at enterprise sites outside of the MPLS core 600.

The POPs are able to access routing information to determine whether more efficient routes are available through the public internet. The POPs are able to access and modify routing tables in order to more efficiently route data traffic. This includes choosing to send traffic directly through and MPLS access link or through the public internet to the MPLS core. The POPs include physical routers running software that measures route latency.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims.

Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. A method for controlling data traffic in a data network, the method comprising:
a data network processor monitoring data traffic, wherein data traffic comprises data traffic between enterprise nodes in an enterprise core network, and wherein the data traffic may be routed among a plurality of core network processors that are controlled by an internet service provider to the enterprise;
a point-of-presence (POP) router collocated with the data network processor receiving routing information from the core network processors and analyzing the routing information to determine whether there are more efficient routes between enterprise nodes than would be available from the core network processors, wherein the routes include the public internet.

2. The method of claim 1, wherein the POP router analyzing the routing information comprises monitoring latency for routes between the enterprise nodes.

3. The method of claim 1, further comprising the POP router:
adjusting data loads considering destinations for data traffic; and
generating a routing table that uses any available core network routers in addition to any internet routers.

4. The method of claim 1, further comprising the POP router obtaining and analyzing a routing table generated by the core network processors.

5. The method of claim 3, wherein if the latency is not acceptable, the POP router:
determines whether the latency can be improved upon;
if the latency can be improved upon, adjusts the data load from any outgoing processor that belongs to a greater latency path to a processor that has a lesser latency path.

6. The method of claim 1, wherein generating a routing plan comprises generating one or more new routing tables, comprising multiple data network processors exchanging probe data regarding route latency.

7. The method of claim 5, wherein:
according to the one or more new routing tables, a destination router may be a same router as a next hop router; and
if it is determined by the data network processor that it is not most efficient for the destination router and the next hop router to be the same, a more efficient next hop router is chosen.

8. The method of claim 1, wherein generating a routing plan comprises employing a multipath routing scheme.

9. A system for data network traffic optimization, the system comprising:
a plurality of enterprise data routers comprising enterprise data network processors;
a plurality of point-of-presence (POP) routers in communication with the plurality of enterprise data network processors, wherein each of the POP routers executes a data traffic routing method comprising,
the POP routers monitoring data traffic, wherein data traffic comprises data traffic between enterprise nodes in an enterprise core network, and wherein the data traffic may be routed among a plurality of core network processors that are controlled by an internet service provider to the enterprise; and
the POP routers receiving routing information from the core network processors and analyzing the routing information to determine whether there are more efficient routes between enterprise nodes than would be available from the core network processors, wherein analyzing comprises comparing latency among routes.

10. The system of claim 9, wherein adjusting data loads further comprises generating a routing table that includes core network processors and internet processors.

11. The system of claim 9, wherein if the latency is not acceptable, the POP router:
determines whether the latency can be improved upon;
if the latency can be improved upon, adjusts the data load from any outgoing processor that belongs to a greater latency path to an outgoing processor that belongs to a lesser latency path, wherein any outgoing processor may be one or more of a core network processor and a public internet processor.

12. The system of claim 10, wherein generating a routing table multiple data network processors exchanging probe data regarding link latency.

13. The system of claim 12, wherein:
according to the one or more new routing tables, a destination router may be a same router as a next hop router; and
if it is determined by the data network processor that it is not most efficient for the destination router and the next hop router to be the same, a more efficient next hop router is chosen.

14. The system of claim 9, wherein analyzing routing information comprises employing a multipath routing scheme.

15. A non-transient computer-readable medium having stored thereon instructions for a data routing method, wherein when the instructions are executed in a processor the method comprises:
a data network processor monitoring data traffic, wherein data traffic comprises data traffic between enterprise nodes in an enterprise core network, and wherein the data traffic may be routed among a plurality of core network processors that are controlled by an internet service provider to the enterprise;
a point-of-presence (POP) router collocated with the data network processor receiving routing information from the core network processors and analyzing the routing information to determine whether there are more efficient routes between enterprise nodes than would be available from the core network processors, wherein the routes include the public internet.

16. The non-transient computer-readable medium of claim 15 wherein the POP router analyzing the routing information comprises monitoring latency for routes between the enterprise nodes.

17. The non-transient computer-readable medium of claim 15, further comprising the POP router:
adjusting data loads considering destinations for data traffic; and
generating a routing table that uses any available core network routers in addition to any internet routers.

18. The non-transient computer-readable medium of claim 15, further comprising the POP router obtaining and analyzing a routing table generated by the core network processors.

19. The non-transient computer-readable medium of claim 18, wherein if the latency is not acceptable, the POP router:
determines whether the latency can be improved upon;
if the latency can be improved upon, adjusts the data load from any outgoing processor that belongs to a greater latency path to a processor that has a lesser latency path.
